(19) United States
(12) Patent Application Publication
(10) Pub. No.: US 2008/0030324 A1
(43) Pub. Date: Feb. 7, 2008

(54) Data communication with sensors using a radio frequency identification (RFID) protocol

(75) Inventors: Benjamin Bekritsky, Hollis, NY (US); Mark Duron, East Patchogue, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/495,579

(22) Filed: Jul. 31, 2006

(51) Int. Cl. G08B 1/08; H04Q 5/22; G08B 13/14

(52) U.S. Cl. 340/539.22; 340/572.1; 340/10.51

(57) ABSTRACT

Methods, systems, and apparatuses for wireless communication using a Radio Frequency Identification (RFID) protocol are described. The system includes a sensor for sensing a condition and converting it into electrical signals. The sensor is coupled to a near field transceiver. The near field transceiver formats the data collected by the sensor and transmits it wirelessly using an RFID protocol to a tag. A reader uses the RFID protocol to wirelessly read the data from the tag.

### BACKGROUND OF THE INVENTION

1. Field of the Invention

The invention relates to radio frequency identification (RFID) technology, and in particular, to wireless communication with sensors using RFID readers.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Because the reader “interrogates” RFID tags, and receives signals back from the tags in response to the interrogation, the reader is sometimes termed as “reader interrogator” or simply “interrogator.”

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

Sensors are typically devices that measure, detect or sense a signal or physical condition, for example, motion, heat or light and convert the condition into an analog or digital representation. There is a need for inexpensive and efficient ways of obtaining data collected by a sensor. However, obtaining data from sensors is difficult due to sensor attributes such as their small size, remote location, lack of complexity etc.

Thus, what is needed are ways to provide inexpensive and effective access to data collected by sensors.

### BRIEF SUMMARY OF THE INVENTION

Methods, systems, and apparatuses for improved wireless communication using Radio Frequency Identification (RFID) protocols and RFID equipment are described herein. A system to collect and transfer data wirelessly using a Radio Frequency Identification (RFID) communication protocol is provided. In an embodiment, the system includes a sensor and near field transceiver circuit. The sensor and near field transceiver circuit includes a data measurement module, a near field transceiver module and an antenna. The system also includes at least one tag, and a RFID reader. The data measurement module is configured to periodically sense a condition, generate data based on the condition and transfer the measured data to the near field reader module. The near field module is configured to format the measured data according to a RFID protocol and periodically wirelessly transmit the formatted data to at least one tag via the antenna and according to the RFID protocol. The reader is configured to periodically wirelessly read the formatted data from the at least one tag according to the RFID protocol.

A method of wireless communication using a Radio Frequency Identification (RFID) communication protocol is provided. The method comprises collecting data using a sensor and transmitting the collected data wirelessly using a RFID communication protocol to a tag using a near field transceiver. The method further comprises reading the formatted data wirelessly from the tag using a reader. The sensor and near field transceiver are physically coupled together on a Printed Circuit Board (PCB), in one embodiment. In another embodiment, the sensor and near field transceiver are on the same substrate of a chip. In another embodiment, the sensor and near field transceiver are closely located.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags.

FIG. 2A illustrates a block diagram of receiver and transmitter portions of a RFID reader.

FIG. 2B illustrates a block diagram of a near field RFID transceiver and its interactions with a tag.

FIG. 3 illustrates a plan view of an example radio frequency identification (RFID) tag.

FIG. 4 illustrates an example a block diagram of a sensor system.

FIG. 5A illustrates an exemplary RFID communication system according to an embodiment of the present invention.

FIG. 5B illustrates another RFID communication system according to an embodiment of the present invention.

FIG. 5C illustrates an embodiment of a sensor and near field transceiver combination according to an embodiment of the present invention.

FIG. 6A illustrates a flowchart showing example steps performed by a RFID data collection and communication system according to an embodiment of the present invention.

FIG. 6B illustrates a flowchart showing example steps performed by a sensor according to an embodiment of the present invention.

FIG. 6C illustrates a flowchart showing example steps performed by a near field RFID transceiver according to an embodiment of the present invention.

FIG. 6D illustrates a flowchart showing example steps performed by a RFID reader according to an embodiment of the present invention.

FIG. 6E illustrates a flowchart showing example steps performed by a RFID tag according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for RFID devices are described herein. In particular, methods, systems, and apparatuses for improved wireless data transfer using RFID systems are described.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Example RFID System

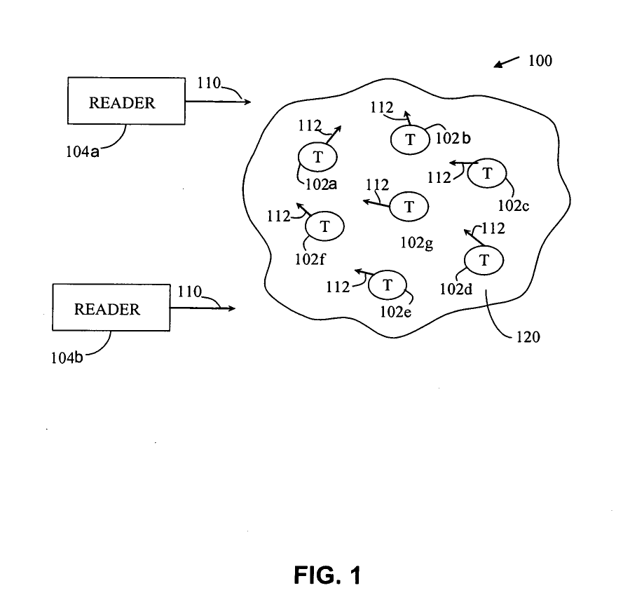

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110a having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

### Example RFID Reader

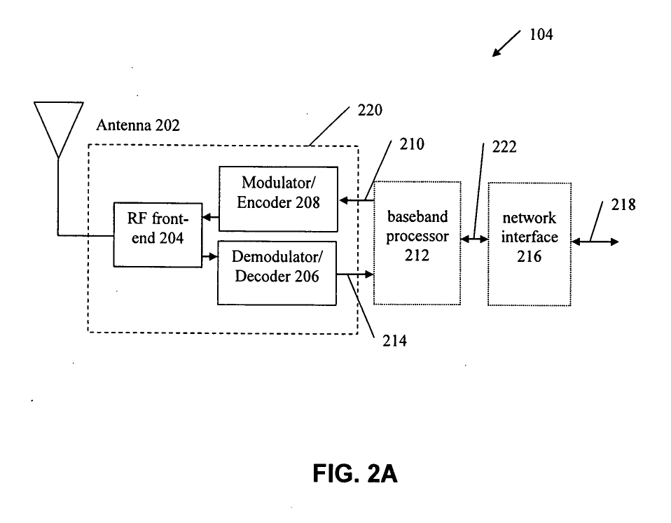

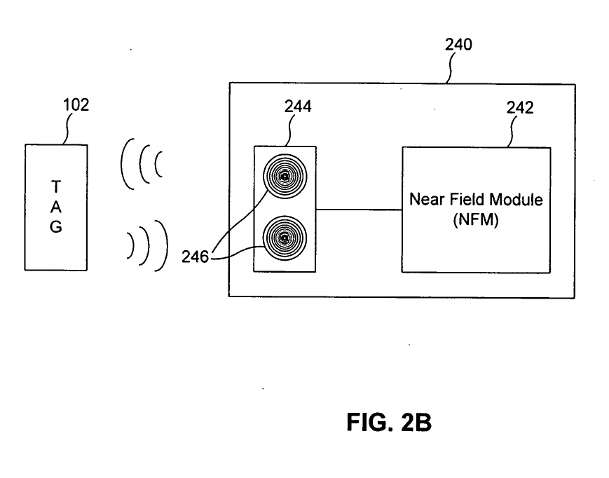

FIG. 2A shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2A, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2A, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as one of pulse-interval encoding (PIE), FM0, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214.

The configuration of transceiver 220 shown in FIG. 2A is provided for purposes of illustration, and is not intended to be limiting. Transceiver 220 may be configured in numerous ways to modulate, transmit, receive, and demodulate RFID communication signals, as would be known to persons skilled in the relevant art(s).

Embodiments of the present invention are described in the following sections. These embodiments enable sensor data to be retrieved from sensors to be provided to tag, and to be read by readers.

### Example RFID Near Field Transceiver Embodiments

Conventional RFID interrogators, such as reader 104, tend to strive to interrogate the highest volume of space allowable by the FCC. This results in the largest amount of RFID tags being interrogated at one time as possible. However, this leads to an inherent difficulty in determining which tag is which among the interrogated tag population. By limiting the read range to contact only, or to proximate range (e.g., in the range of inches or feet), as in near field transceiver 240, the uncertainty of volumetric interrogations is reduced or eliminated.

In antenna design, a near field is that part of the radiated field that is within a small number of wavelengths or one quarter of a wavelength of the diffracting edge or the antenna. Beyond the near field is the far field. Reader 104 typically utilizes a far field antenna 202.

FIG. 2B illustrates a near field transceiver 240 comprising a near field module (NFM) 242 and near field antenna 244. Near field transceiver 240 is configured to receive data from a sensor, and transmit the data to a tag. In an embodiment, near field antenna 244 comprises coils 246a and 246b. For description of an example antenna and oscillator circuit suitable for near field transceiver 240, refer to U.S. Patent Application Ser. No. 60/784,450, filed Mar. 22, 2006, titled “Single Frequency Low Power RFID Device,” now pending, which is incorporated by reference herein in its entirety.

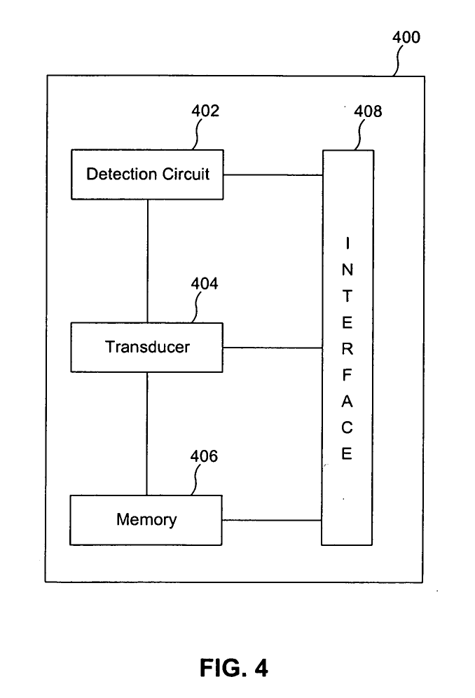

Near field transceiver 240 is designed to incorporate similar functions as reader 104 while occupying a comparatively small area and having a much lower cost. Near field module 242 may incorporate circuits functionally similar to one or more of RF front end 204, modulator/encoder 208, demodulator 206, baseband processor 212 and network interface 216. Additionally, embodiments of the invention such as elements 502, 508 and 510 can operate on low power due to the relatively low amounts of power required for near field transmission as opposed to far field transmission. This results in a substantial energy savings when operating from for example, battery powered sources. In an embodiment, near field module 242 is implemented as part of an Integrated Circuit (IC) or an Application Specific Integrated Circuit (ASIC) of a sensor, as in sensor 400 in FIG. 4. Near field module 242 may be implemented as hardware, software, firmware or any combination thereof.

Near field transceiver 240 is typically much smaller than reader 104, although this is not necessary. As such, near field transceiver 240 can be incorporated in devices, mobile or stationary, to read tags in a near field fashion, such as in a “contact” or nearby fashion. For example, as shown in FIG. 2B, a near field transceiver 240 can be moved into contact with a tag 102 (e.g., moving antenna 244 in contact with an antenna of tag 102) to read or write to tag 102, or can be moved proximate to tag 102 (e.g., within inches or feet) to read or write to tag 102.

### Example RFID Tag

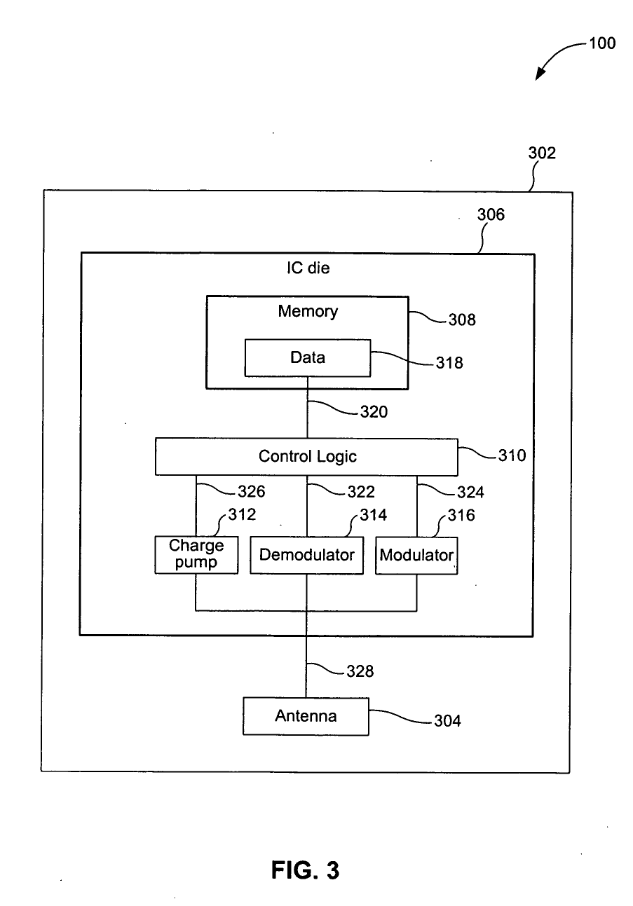

The present invention is applicable to any type of RFID tag. FIG. 3 shows a plan view of an example RFID tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328.

Memory 308 is typically a non-volatile memory, but can alternatively be a volatile memory, such as a DRAM. Memory 308 stores data 318 which includes an identification number. The identification number typically is a unique identifier (at least in a local environment) for tag 102. For instance, when tag 102 is interrogated by a reader (e.g., receives interrogation signal 110 shown in FIG. 1), tag 102 may respond with its identification number to identify itself. A tag's identification number may be used by a computer system to associate tag 102 with its particular associated object/item. In an embodiment, using a RFID communication protocol such as the EPC Gen 2 protocol, reader 104 or near field transceiver 240 can write data to memory 308 of tag 102. For example the “Write” and “BlockWrite” commands specified in the EPC Gen2 specification allow a word or multiple words to be written to tag memory 308 respectively.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number stored in data 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 is used to power circuits of IC die 306, including control logic 320.

Charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3 as a passive tag, tag 102 may alternatively be an active tag (e.g., powered by battery).

### Sensors

A sensor is typically a device having a sensing element that measures, detects or senses a signal or physical condition, such as motion, heat or light and converts the measured condition into an analog or digital representation. For example, an optical sensor detects the intensity or brightness of light, or the intensity of colors such as red, green and blue, and converts the measurement into an electrical signal for color systems. Sensors are heavily used in medicine, industry and robotics.

Most sensors are electrical or electronic, although other types exist. Types of sensors include but are not limited to motion sensors such as radar gun, speedometer, tachometer, odometer and turn coordinator; orientation sensors such as gyroscopes and ring laser gyroscopes; sound sensors such as microphones, hydrophones and seismometers; electromagnetic sensors such as ohmmeters and voltmeters; thermal energy sensors such as thermistors; mechanical sensors such as altimeters, gas meters acceleration sensors and position sensors; chemical sensors such as oxygen sensors and redox electrodes; ionizing sensors such as Geiger counters and scintillometers; non-ionizing sensors such as photocells and photodiodes. It is to be appreciated that sensors are not limited to examples presented above.

FIG. 4 illustrates an example sensor system (SS) 400 including a detection circuit 402, a transducer 404, memory 406 and an interface 408. Detection circuit 402 is a sensing element (such as those described above) used to detect a signal or physical condition. Transducer 404, if required, is used to convert the condition detected by detection circuit 402 into an electrical signal to allow storage in memory 406. Memory 406 is optionally present to store sensor data. Optional interface 408 may be used to present the information stored in memory 406, information from transducer 404 or directly from detection circuit 402 (e.g., in an audio/video format). The elements of system 400 may be those conventionally found in sensors, or may be special purpose elements.

Embodiments of an improved RFID communication system are described in further detail below. Such embodiments interact with the tags described above, other tag types, near field transceivers and readers and/or may be used in alternative environments. Furthermore, the embodiments described herein may be adapted and modified, as would be apparent to persons skilled in the relevant art(s).

### Example Embodiments

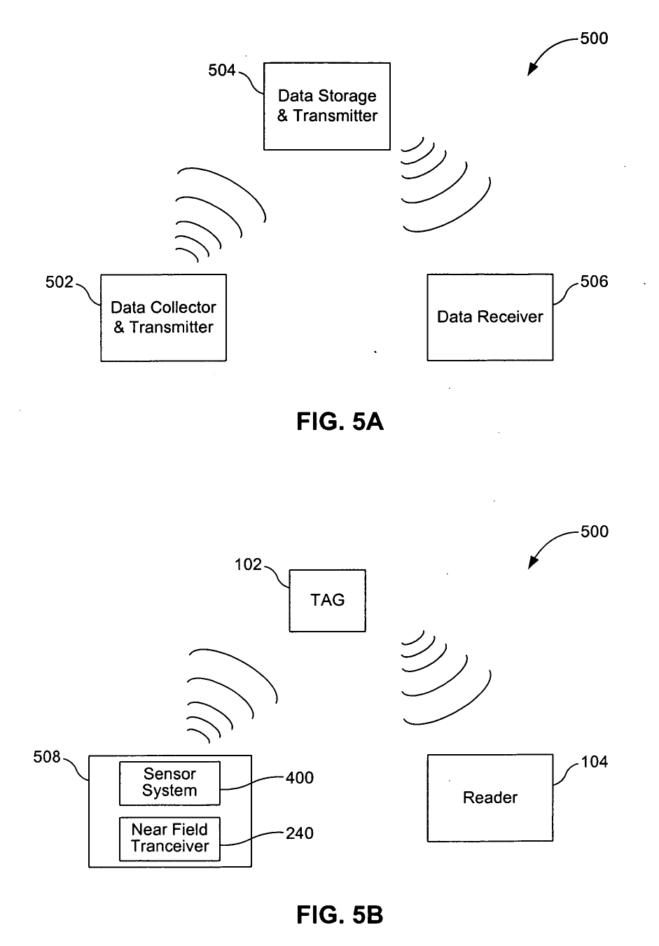

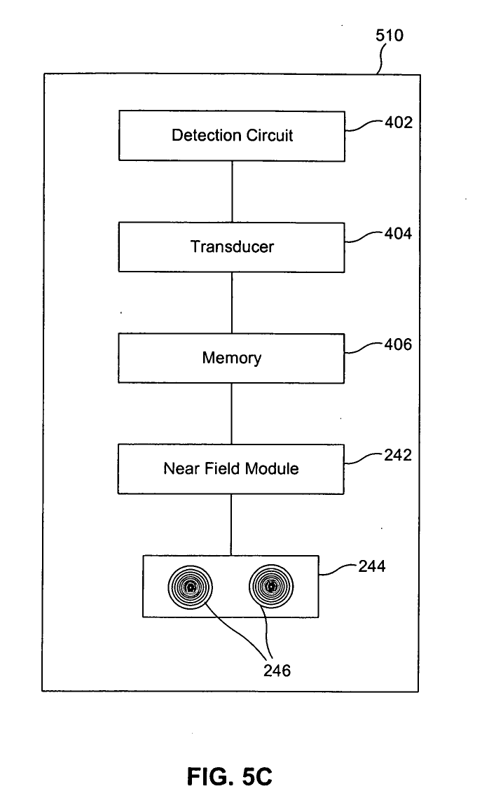

FIG. 5A illustrates an example system 500 to collect data and wirelessly transmit the data using a RFID protocol according to an embodiment of the invention. System 500 comprises a data collector and transmitter 502, a data storage and transmitter 504 and a data receiver 506. Data collector and transmitter 502 collects data and transmits the data to data storage and transmitter 504. Data storage and transmitter 504 receives the data and transmits stored data to data receiver 506. In an embodiment, data storage and transmitter 504 transmits the stored data upon receiving an explicit request from data receiver 506.

FIG. 5B illustrates an exemplary embodiment of the system 500 according to an embodiment of the invention. In this embodiment, data collector and transmitter is a combined sensor and near field transceiver (SNFT) 508, data storage and transmitter 502 is tag 102 and data receiver 506 is reader 104. For example, in an embodiment, SNFT 508 includes SS 400 (shown in FIG. 4) coupled with NFTM 240 on a circuit board (such as a Printed Circuit Board (PCB)). SS 400 is programmed to collect data intermittently or periodically, depending on design specifications. The data sensed and collected by SS 400 may be one of the sensor data types described above or may be other data types. The collected data by SS 400 is formatted by NFTM 240, if required, according to an RFID protocol such as the EPC Gen 2 protocol. The formatted data is then transmitted by NFTM 240 to tag 102 using a RFID protocol such as that specified in the EPC Gen 2 protocol. In an embodiment, NFTM 240 uses the “Write” or “BlockWrite” commands specified in the EPC Gen 2 protocol to write data collected by SS 400 to a tag memory 308. Reader 104, either periodically or intermittently, depending on the particular application, interrogates tag 102. Tag 102 backscatters the formatted data stored in memory 308, in response to the interrogation. Reader 104 interrogates tag 102 using commands such as “Read” as described in the EPC Gen 2 specification.

FIG. 5C illustrates an example embodiment of data collector and transmitter 502 in which certain modules of SS 400 and NFT 240 are combined together in a single chip to form sensor and near field module (SNFM) 510. In this example, detection circuit module 402 detects or senses a physical condition. The detected condition may be transduced into electrical signals or into a storage format as required by optional transducer 404. The signals from detection circuit module 402 or transducer 404 are stored in memory 406 which is memory shared with NFM 242. NFM 242 formats the stored data, if required, into a RFID format according to an RFID protocol such as EPC Gen 2. NFM 242 uses antenna 244 to transmit the formatted data stored using a RFID protocol such as the EPC Gen 2.

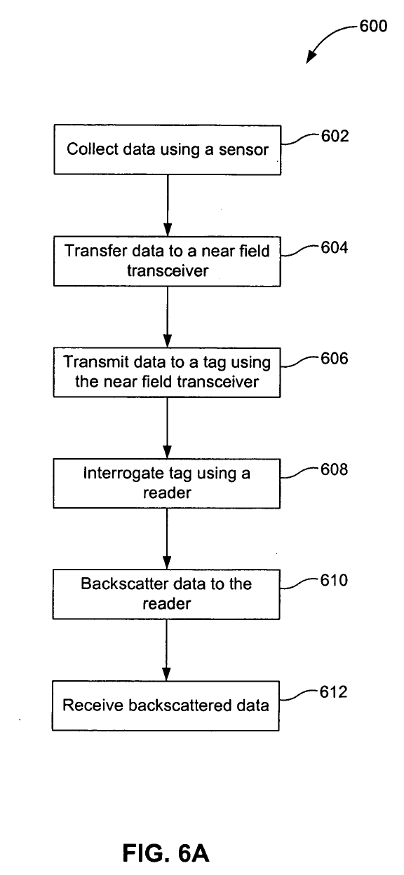

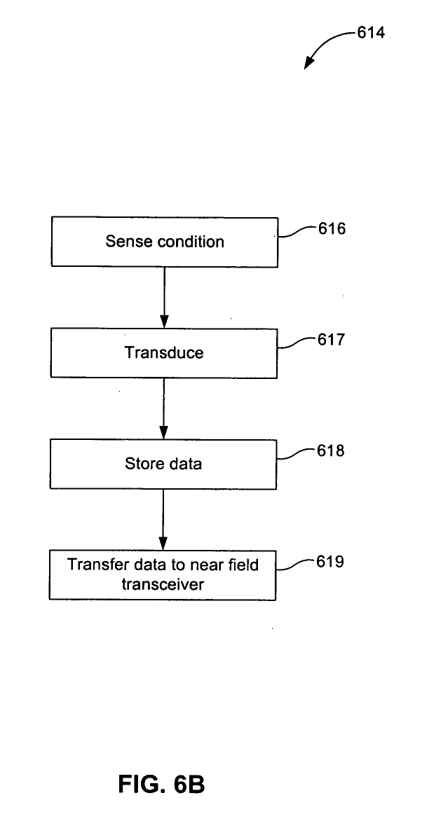

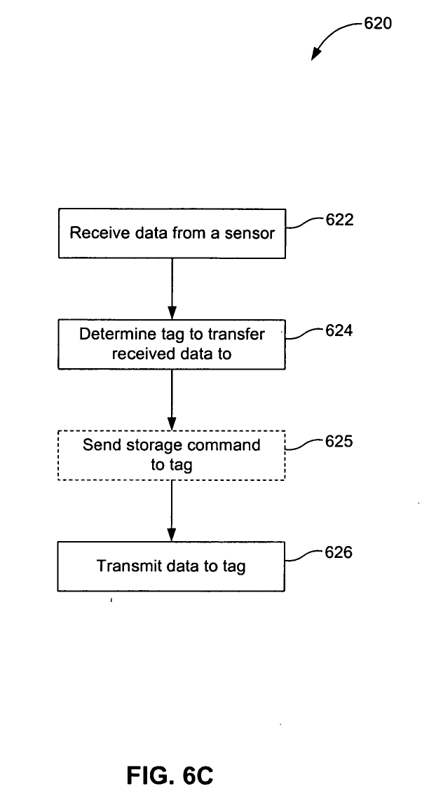

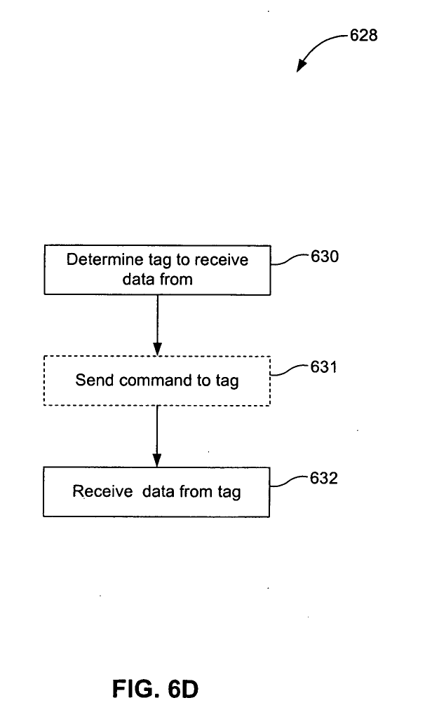

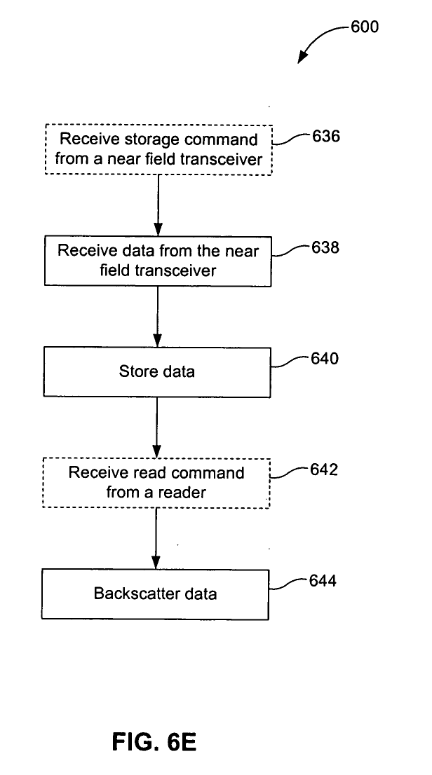

FIG. 6A illustrates a flowchart 600 showing steps performed by a RFID data collection and communication system according to an embodiment of the present invention.

In step 602, a sensor collects data. For example, in an embodiment, a sensor detects a signal or physical condition, transduces the detected data into electrical signals or into a suitable format for storage. For instance, the sensor may be the sensor system 400 shown in FIG. 4 or FIG. 5C.

In optional step 604, the sensor transfers the data collected in step 602 to a near field transceiver. For example, in an embodiment the near field transceiver is near field transceiver 240. In one embodiment, the near field reader and the sensor are on the same PCB requiring transfer of data from the sensor memory to the near field transceiver memory (e.g., as shown in FIG. 5B). In another embodiment, the near field transceiver and sensor are either on the same chip or share memory thereby obviating step 604 (e.g., as shown in FIG. 5C).

In step 606, the near field transceiver formats the collected data, if required, according to an RFID protocol and transmits the formatted data to one or more tags using an RFID transmission protocol such as EPC Gen 2. In one embodiment, the near field transceiver transmits data to only one tag whose identification is pre-programmed in the near field transceiver. The tag is either in contact with the near field transceiver or proximate to the near field transceiver. In another embodiment, the near field transceiver interrogates tags in close proximity and transmits data to one or more responsive tags.

In step 608, a reader interrogates one or more tags for data. For example, in an embodiment, the reader is reader 104 shown in FIG. 5B. In an embodiment, the reader uses a predetermined tag identification number to identify and interrogate a specific tag that stores the data transmitted by the near field transceiver.

In step 610, the tag or tags, in response to the interrogation in step 608, backscatter the data received from the near field transceiver in step 606.

In step 612, the reader receives the backscattered data from one or more tags.

FIG. 6B illustrates a flowchart 614 showing steps performed by a sensor according to an embodiment of the invention. For example, in an embodiment, the sensor is sensor system 400.

In step 616, a sensor detects or senses a physical condition. The sensor may sense any type of condition, including but not limited to the types of conditions described above. The sensor may be programmed to sense a condition periodically or intermittently. In an embodiment, the sensor may sense data only on occurrence of a certain event or trigger. For example, a sensor may trigger and sense a physical condition based on movement or change in light, temperature or pressure conditions.

In optional step 617, the sensor transduces the collected data into electrical signals or into a suitable format for storage.

In step 618, the sensor stores the data from step 616 or the transduced data from step 617 in memory. Step 618 is optional. For example, when present, the memory may be data storage 406.

In step 619, the sensor transfers data to a near field transceiver. In an embodiment, the near field transceiver is on the same PCB as the sensor and the sensor may transfer the data to a near field transceiver memory (e.g., shown in FIG. 5B). In another embodiment, the sensor and the near field transceiver are on the same chip with a shared memory (e.g., as shown in FIG. 5C). In this embodiment, a transfer of data is not required, obviating step 619.

FIG. 6C illustrates a flowchart 620 showing example steps performed by a near field transceiver according to an embodiment of the invention. For example, in an embodiment, the near field transceiver is near field transceiver 240.

In step 622, the near field transceiver receives data collected by a sensor. The data may be received via an interconnect on a PCB or via memory shared by the sensor and the near field transceiver. The near field transceiver may receive the data periodically or intermittently. In an embodiment, the near field transceiver may query the sensor for data.

In step 624, the near field transceiver determines one or more tags to transfer the data received in step 622. In an embodiment, the near field transmitter transmits data to a predetermined tag. In another embodiment, the near field transmitter interrogates tags in its immediate vicinity or near field range and selects one or more responsive tags to transmit to.

In step 625, the near field transceiver sends a storage command such as the “Write” or “BlockWrite” command specified in the EPC Gen 2 specification to one or more tags determined in step 624. The command may indicate that the near field transceiver is about to transmit data for storage. In other RFID protocols, there may be no need to signal prior transmission of data.

In step 626, the near field transmitter formats the data according to an RFID protocol such as EPC Gen 2, if required, and transmits the formatted data to one or more tags determined in step 624 using an RFID protocol such as EPC Gen 2.

FIG. 6D illustrates a flowchart 628 showing steps performed by a reader according to an embodiment of the invention. For example, the reader is reader 104 shown in FIG. 5B.

In step 630, the reader determines one or more tags to interrogate for data. In an embodiment, the reader interrogates a predetermined tag for data. In another embodiment, the reader interrogates tags within in its range and selects one or more responsive tags to receive data from.

In optional step 631, the reader uses a command such as the “Read” command in the EPC Gen 2 specification to instruct one or more tags selected in step 630 to backscatter data stored in their memory.

In step 632, the reader receives and processes backscattered data from one or more tags. The reader may receive similar or different data from one or more tags. For example, the reader may receive temperature and light conditions from distinct tags. In another example, the reader may receiver multiple temperature values from distinct tags and average them.

FIG. 6E illustrates a flowchart 634 showing steps performed by a tag according to an embodiment of the invention. For example, in an embodiment, the tag is tag 102 shown in FIG. 5B.

In step 636, a tag receives a “Write” or “BlockWrite” command from a near field transceiver.

In step 638, the tag receives data from the near field transceiver.

In step 640, the tag stores the data received from the near field transceiver in an internal memory.

In optional step 642, the tag receives a command such as the “Read” command as in the EPC Gen 2 specification from a reader.

In step 644, the tag backscatters data stored in step 640.

### Example Advantages

By limiting the amount of power required to a level needed to write to tags at proximate ranges, the amount of DC power required to generate the RF signals by a near field transceiver 240 is two to three orders of magnitude lower than that used in a far field high power volumetric reader, such as reader 104. This results in a substantial energy savings when operating from for example, battery powered sources. This further results in substantial reductions of generated heat when using a sensor and near field combination as in systems 508 and 510.

By limiting an effective radiated power to an amount required to interrogate at proximate ranges, the radiating antenna (e.g., antenna 244) can be made very small, with a corresponding reduction in antenna gain. This allows the antenna size to be reduced from a bulky 4″ to 6″ square patch, or linear radiator to as little as a 0.7 inch square patch, or other small size. Such an antenna acts as a near field E-field coupling device, although it could also be a near field inductive coupling loop. This antenna has the tendency to radiate very little into the far field, but when placed in close proximity or contact with an RFID tag, such as tag 102, will give up substantially more energy to the RFID tag through the near field coupling mechanism, enabling accurate reads.

By limiting an effective radiated power to an amount required to write to tags at only contact or proximate ranges, the radiating antenna can be made very small, with a corresponding reduction in antenna gain. This reduces the amount of RF susceptibility for a sensor-near field transceiver combination to other interfering readers. Furthermore, this reduces the amount of RF interference that a sensor-near field transceiver combination presents to other readers. Still further, any undesired interaction with other circuitry housed within the mobile terminal in minimized (e.g., when NFTM 240 is housed with sensor 400 as in system 508).

In an embodiment, by placing systems 508 and 510 in close proximity to an RFID tag 102 being read, the tag being read becomes detuned by the presence of antenna 244. It therefore becomes much harder for an interfering reader to jam the interrogation and/or writing process of the present reader.

In an embodiment, systems 508 and 510 as described herein can be made at very low cost (e.g., <$20 in parts) and can operate at low power (e.g., 100 ma @ 5V peak). This is because of the very low cost and very power efficient components utilized by systems 508 and 510 described herein, such as a SAW oscillators, lower power amplifiers, etc. Furthermore, the lower broadcast power enables passing FCC requirements without the need for frequency hopping. This further lowers cost.

In an embodiment, systems 508 and 510 are configured to use a “near-field” antenna configuration, including in a patch, linear, or loop antenna configuration. Another near-field antenna example is a lossy transmission line type antenna.

Furthermore, due to the shorter range of transmitted signals, there is less portal interference. For example, embodiments such as systems 508 and 510 which pair sensors with near field transceivers, may have an interference range of a few meters, whereas if a sensor is paired with a reader, it may have an interference range as much as a mile or more.

In an embodiment a flexible substrate may be used to mount NFTM 240 and SS 400. The flexible substrate may be made from a flexible material, such as a plastic, polymer, or other substrate material that flexes. Because the substrate flexes, and can thus be shaped, it enables circuits to be positioned in and on objects, such as mobile devices, in a variety of configurations. Furthermore, the flexible substrate may have an adhesive backing to enable easy attachment to a surface.

A motion sensor, such as a “MEMS” (micro-electromechanical system) motion sensor, may be present for enhanced power management. For example, a motion sensor may enable the device to go into sleep mode when no motion is being detected.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system (e.g., a reader or host) using a removable storage drive, hard drive, or communications interface. The control logic (software), when executed by a processor, causes the processor to perform the functions of the invention as described herein. Still further, a sensor may execute computer readable instructions to collect data. Still further, a near field transceiver may execute computer readable instructions to communicate with sensors and/or tags.

According to an example embodiment, a reader may execute computer-readable instructions to read tags, as described above. Furthermore, in an embodiment, a tag may execute computer-readable instructions to respond to a reader transmitted signal, as further described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system to collect and transfer data wirelessly using a Radio Frequency Identification (RFID) communication protocol, comprising:
a sensor and near field transceiver circuit, including:
a data measurement module;
a near field transceiver module; and
an antenna;
at least one tag; and
a RFID reader;
wherein said data measurement module is configured to periodically sense a condition, generate data based on the condition and transfer the generated data to the near field reader module;
wherein said near field transceiver module is configured to format said generated data according to a Radio Frequency Identification (RFID) protocol and transmit said formatted data to at least one tag via said antenna according to the RFID protocol; and
wherein said reader is configured to read said formatted data from said at least one tag according to the RFID protocol.

2. The system of claim 1, wherein said sensor and near field transceiver circuit further comprises a transducer.

3. The system of claim 1, wherein said sensor and near field transceiver circuit further comprises a memory.

4. The system of claim 1, wherein said sensor and near field transceiver circuit is configured to use a “Write” or “BlockWrite” command of Electronic Product Code (EPC) Gen 2 protocol to transmit said formatted data to at least one tag.

5. The system of claim 1, wherein said reader is configured to use a “Read” command of Electronic Product Code (EPC) Gen 2 protocol to obtain said formatted data from at least one tag.

6. The system of claim 1, wherein said at least one tag includes memory.

7. A system to collect and transmit data using a Radio Frequency Identification (RFID) communication protocol, comprising:
a sensor configured to sense a condition and generate data based on the condition; and
a near field transceiver coupled to said sensor and configured to receive the generated data;
wherein said near field transceiver is configured to transmit said data received from said sensor to a tag according to the RFID protocol.

8. The system of claim 7, wherein the tag is identified via a tag identification number.

9. The system of claim 7, further comprising a Printed Circuit Board (PCB), wherein said sensor and said near field transceiver are mounted on said PCB.

10. The system of claim 7, further comprising an Integrated Circuit (IC), wherein said sensor and said near field transceiver are part of said IC.

11. The system of claim 7, further comprising a flexible substrate, wherein said sensor and near field transceiver are on said flexible substrate.

12. The system of claim 7, wherein said sensor further comprises a detection circuit, a transducer and a memory.

13. The system of claim 7, wherein said near field transceiver further comprises a near field antenna.

14. A method of wireless communication using a Radio Frequency Identification (RFID) communication protocol, comprising:
sensing a physical condition;
collecting data for the sensed physical condition; and
transmitting said collected data via the RFID protocol to a tag, using a near field communication signal.

15. The method of claim 14, further comprising reading said collected data from said tag via the RFID protocol, using a far field communication signal.

16. The method of claim 14, further comprising, prior to said transmitting step, formatting said collected data according to the RFID protocol.

17. The method of claim 14, wherein said collecting step further comprises transducing said sensed physical condition into electrical signals suitable for storage.

18. A method of wireless communication using a Radio Frequency Identification (RFID) communication protocol, comprising:
receiving sensed data; and
transmitting the received data to a tag located in a near field range, according to the RFID communication protocol.

19. The method of claim 18, wherein said transmitting step further comprises contacting said tag with a transmitting antenna that transmits the sensed data.

20. The method of claim 18, further comprising positioning a transmitting antenna within a near field range of the tag, wherein the transmitting antenna transmits the sensed data.

21. The method of claim 18, further comprising sending a storage command to the tag.

22. The method of claim 18, further comprising, prior to said transmitting step, formatting said received data according to the RFID protocol.

23. The method of claim 18, further comprising transmitting said received data periodically or intermittently.

24. A method of wireless communication in a tag, comprising:
receiving sensed data in a near field communication signal according to a Radio Frequency Identification (RFID) communication protocol;
receiving an RFID interrogation signal; and
transmitting the received data in response to the RFID interrogation signal.

25. The method of claim 24, wherein said receiving sensed data step further comprises contacting said tag with a transmitting antenna that transmits the sensed data.

26. The method of claim 24, wherein said receiving sensed data step further comprises receiving the near field communication signal from a transmitting antenna that transmits the sensed data within a near field range of the tag.
